(19) United States
(12) Patent Application Publication
(10) Pub. No.: US 2012/0098863 A1
(43) Pub. Date: Apr. 26, 2012

(54) METHOD AND APPARATUS FOR CREATING A FLEXIBLE USER INTERFACE

(75) Inventors: CRISTIAN ALMSTRAND, ENCINITAS, CA (US); TONNI LARSEN, ESCONDIDO, CA (US)

(73) Assignee: SONY CORPORATION, Tokyo (JP)

(21) Appl. No.: 12/909,627

(22) Filed: Oct. 21, 2010

(51) Int. Cl. G09G 5/00

(52) U.S. Cl. 345/650

(57) ABSTRACT

A method and apparatus for creating a flexible display for a user interface device is disclosed. In some embodiments, the method includes processing graphical icon information for the user interface device, wherein each graphical icon corresponds with at least one operation on the user interface device, coupling the graphical icon information with gravity information, wherein the each graphical icon maps to at least one gravitational attribute, wherein the at least one gravitational attribute corresponds with motion of the graphical icon relative to the user interface device and in response to an orientation change of the user interface device, generating the each graphical icon at a position determined by the at least one gravitational attribute.

### BACKGROUND

1. Technical Field

Embodiments of the present disclosure generally relate to image processing systems and, more particularly, to a method and apparatus for creating a flexible user interface.

2. Description of the Related Art

Many devices function as user interfaces for controlling other devices (e.g., computing, such as televisions, cameras, media players, sound systems, computers and/or the like). For example, a remote control device is used to operate a television or a laptop computer. Each user interface device includes buttons (e.g., physical buttons, touch screens and/or the like) that are formed on at least one surface. These buttons correspond with specific operations at the other device. For example, a certain button is depressed for powering on/off the television. Sometimes, the user interface device is coupled to the device being controlled. In other words, the device being controlled also includes a user interface for direct control (e.g., APPLE® IPad).

Some of these user interface devices employ a graphical display (i.e., a screen, such as a touch screen) on which a plurality of graphical icons are rendered. Each graphical icon represents a graphical form of a particular physical button. The user touches the graphical icon in order to remote control the other device, such as the television, in the same manner as the physical buttons. The graphical display is substantially rectangular shaped in order to restrain movement of the plurality of graphical icons in response to movement at the user interface device. As such, the plurality of graphical icons can only be rotated in ninety (90°) increments (e.g., clockwise, counter clockwise and/or the like). Current user interface devices cannot rotate the graphical icons less than 90°.

Therefore, there is a need in the art for a method and apparatus for creating a flexible user interface that changes the orientation of the graphical icons in response to a change in orientation of the user interface device.

### SUMMARY

Various embodiments of the present disclosure generally include a method and apparatus for creating a flexible display for a user interface device. In some embodiments, the method includes processing graphical icon information for the user interface device, wherein each graphical icon corresponds with at least one operation on the user interface device, coupling the graphical icon information with gravity information, wherein the each graphical icon maps to at least one gravitational attribute, wherein the at least one gravitational attribute corresponds with motion of the graphical icon relative to the user interface device and in response to an orientation change of the user interface device, generating the each graphical icon at a position determined by the at least one gravitational attribute.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a block diagram of a system for providing a user interface for controlling a computing device in accordance with at least one embodiment;

FIG. 2 illustrates a screen configuration that is displayed on a user interface device in accordance with at least one embodiment;

FIG. 3 illustrates a flow diagram of a method of creating a flexible user interface in accordance with at least one embodiment;

FIG. 4 illustrates a flow diagram of a method of controlling a computing device using an user interface device in accordance with at least one embodiment; and

FIG. 5 illustrates a flow diagram of a method of rotating a screen configuration on a user interface device in accordance with at least one embodiment.

### DETAILED DESCRIPTION

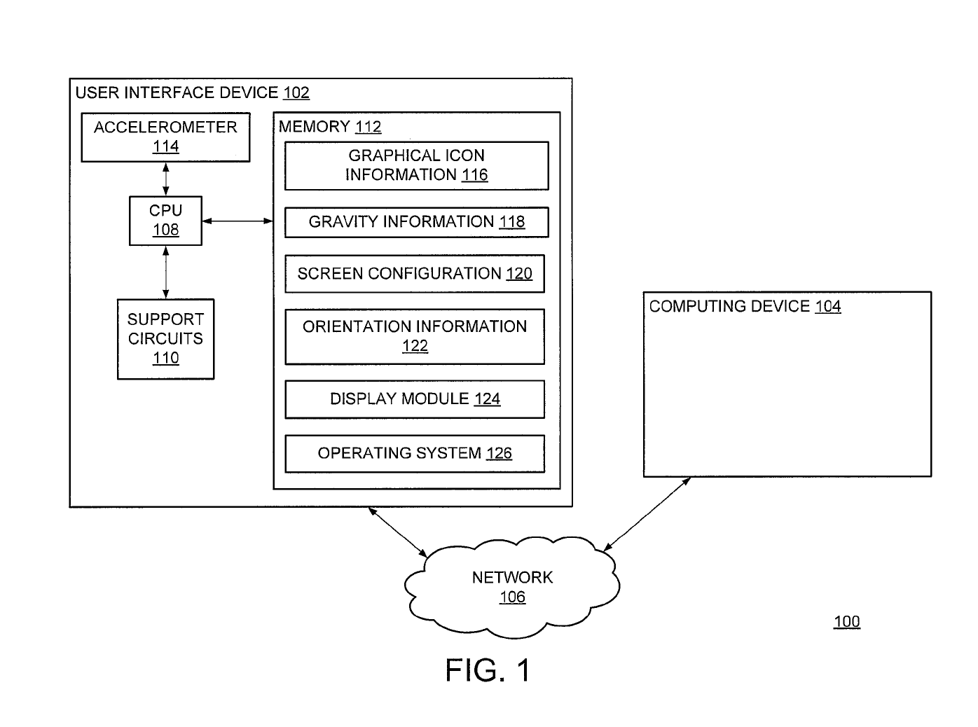

FIG. 1 illustrates a system 100 for using a user interface device 102 for controlling a computing device 104 in accordance with at least one embodiment. The user interface device 102 communicates with the computing device 104 through a network 106. It is appreciated that the computing device 104 includes any device that is remotely controlled by the user interface device 102.

In other embodiments, the user interface device 102 and the computing device 104 couple together and form a unitary device. Such a unitary device is a non-remote control device and may include mobile phones, hand-held computing devices (e.g., Apple® IPad) and/or navigational systems (e.g., Global Positioning Systems (GPS)) where maps are rotated based on either a compass or a change in subsequent GPS coordinates.

In some embodiments, the user interface device 102 comprises a Central Processing Unit (CPU) 108, support circuits 110 and a memory 112. The CPU 108 comprises one or more microprocessors or microcontrollers that facilitate data processing and storage. The support circuits 110 facilitate operation of the CPU 108 and include clock circuits, buses, power supplies, input/output circuits and/or the like. The memory 112 includes a read only memory, random access memory, disk drive storage, optical storage, removable storage, and the like. The memory 112 includes various data, such as graphical icon information 116, gravity information 118, screen configuration 120 and orientation information 122. The memory 106 further includes various software packages, such as a display module 124 and an operating system 126.

In some embodiments, the user interface device 102 further comprises a hardware component, such as an accelerometer 114, to provide the orientation information 122. It is appreciated that in other embodiments, another hardware component (e.g., an inclinometer or a gyroscope) may be utilized to determine an orientation of the user interface device 102. Collectively, these hardware components constitute a means for providing the orientation information 122.

The network 106 comprises a communication system that connects computing devices by wire, cable, fiber optic, and/or wireless links facilitated by various types of well-known network elements, such as hubs, switches, routers, and the like. The network 106 may employ various well-known protocols to communicate information amongst the network resources. For example, the network 106 may be part of the Internet or intranet using various communications infrastructure such as Ethernet, WiFi, WiMax, General Packet Radio Service (GPRS), and the like.

The accelerometer 114 includes a hardware component that generates and stores the orientation information 122. After recognizing a change in orientation of the user interface device 102, the accelerometer 114 updates the orientation information 122 with a current orientation. For example, the orientation information 122 may indicate that a display (i.e., a screen) on the user interface device 102 is facing upwards and parallel to a ground. As another example, the orientation information 122 may indicate a change from this orientation in which the display is now facing downwards.

The graphical icon information 116 provides details regarding one or more graphical icons. In some embodiments, the graphical icon information 116 includes metadata for each graphical icon that indicates a name, a file name for graphics data, one or more associated operations and/or the like. For example, the graphical icon information 116 may describe graphical icons (i.e., buttons) that control operations of a television (e.g., power on/off, channel change, digital video recorder functions and/or the like).

The gravity information 118 includes at least one gravitational attribute for each graphical icon of the graphical icon information 116. In some embodiments, each gravitational attribute represents a response of a particular graphical icon to motion or movement (e.g., positioning and/or rotation) of the user interface such that the particular graphical icon maintains an optimal orientation to be displayed. Using the each gravitational attribute, a position of the particular graphical icon is computed if such movement causes an orientation change of the user interface device 102 according to some embodiments. In other words, the each gravitational attributes indicates an amount of displacement from a current position of the particular graphical icon after the user interface device 102 is moved.

The screen configuration 120 includes information for describing a layout or orientation of one or more graphical icons on a display (i.e., a screen). The screen configuration 120 indicates a position on the display for each graphical icon being generated according to some embodiments. Each position is computed using the gravity information 118. As such, these positions compliment an orientation of the user interface device 102 to provide a clear and correctly spaced display of the one or more graphical icons.

The display module 124 includes software code (processor executable instructions) for providing a user interface that controls functionality of the computing device 104. In response to a change in orientation of the user interface device 102, the display module 124 adjusts a current position of each graphical icon by rendering the each graphical icon at a new position according to some embodiments. For example, the display module 124 moves the each graphical icon around the screen relative to movement of the user interface device 102. In some embodiments, the display module 124 rotates each and every graphical icon in a direction (e.g., clockwise or counterclockwise) for a certain number of degrees (e.g., more or less than 90°).

The operating system 126 generally manages various computer resources (e.g., network resources, data storage resources, file system resources and/or the like). The operating system 126 is configured to execute operations on one or more hardware and/or software devices, such as Network Interface Cards (NICs), hard disks, virtualization layers, firewalls and/or the like. For example, the various software packages call commands associated with the operating system 126 (i.e., native operating system commands) to perform various file system and/or storage operations, such as creating files or metadata, writing data to the files, reading data from the files, modifying metadata associated with the files and/or the like. The operating system 126 may call one or more functions associated with device drivers to execute various file system and/or storage operations.

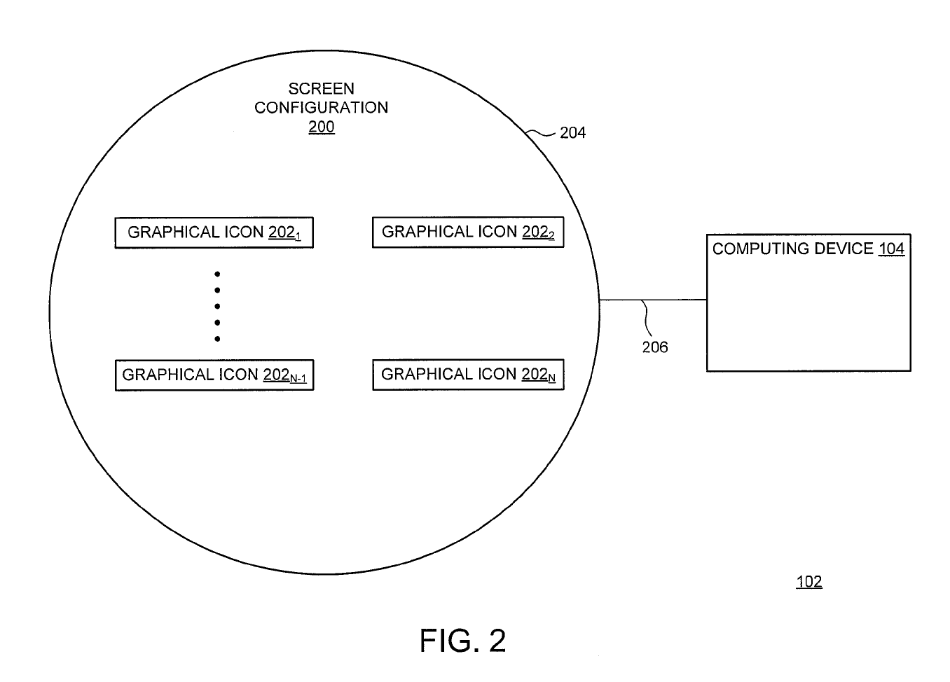

FIG. 2 illustrates a screen configuration 200 that is displayed on the user interface device 102 in accordance with at least one embodiment. As illustrated, the screen configuration 200 includes a plurality of graphical icons 202 that are generated and viewed on a display 204. Each of the plurality of graphical icons 202 may be depicted as a graphical icon 202ᵢ. The display 204 generally refers to a screen (i.e., a touch screen) on the user interface device 102 for presenting the plurality of graphical icons 202 to a user. Through the plurality of graphical icons 202, the user remotely controls operations at another device (e.g., the computing device 104 of FIG. 1), such as a television or a computer according to some embodiments.

Although the display 204 of the user interface device 102 is illustrated as substantially circular in shape, it is appreciated that the display may form any shape. As a user moves the user interface device 102, the screen configuration 200 maintains a pose that faces the user to provide optimal viewing. When the user interface device 102 is rotated during normal use, the screen configuration 200 is also rotated in an opposite direction and with substantially the same angular displacement according to some embodiments. For example, if a user rotates the user interface device 102 thirty (30°) degrees counterclockwise, the screen configuration 200 responds by rotating 30° clockwise.

The user interface 102 is coupled to the computing device 104 via a communication link 208. Generally, the communication link 208 is established using antennas on both the user interface device 102 and the computing device 104. The communication link 208, however, may be a physical link (e.g., a wire) or path for instructions to transmit. In other words, the user interface device 102 and the computing device 104 constitute a single device (e.g., a non-remote control device, such as a navigation system) or system of devices. According to such alternate embodiments, the screen configuration 100 may rotate less than 90° based on a compass or a change in subsequent GPS coordinates (e.g., rotating a map in a single dimension).

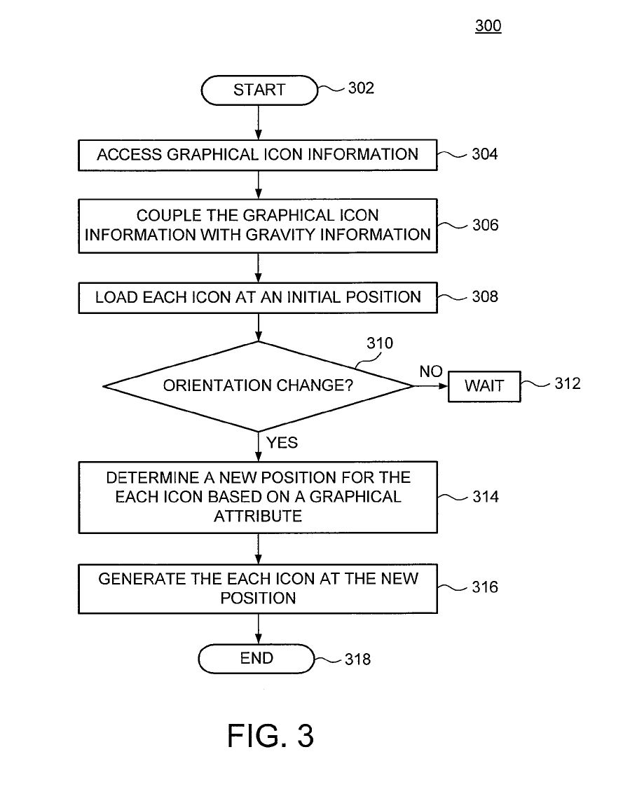

FIG. 3 illustrates a flow diagram of a method 300 of creating a flexible user interface in accordance with at least one embodiment. Each and every step of the method 300 may be performed by a display module. In some embodiments, one or more steps are omitted. The method 300 starts at step 302 and proceeds to step 304. At step 304, the method 300 accesses graphical icon information. The graphical icon information (e.g., the graphical icon information 116 of FIG. 1) describes various data for each graphical icon.

At step 306, the method 300 couples the graphical icon information with gravity information. The gravity information (e.g., the gravity information 118 of FIG. 1) includes one or more gravitational attributes that affect motion of the each graphical icon. By mapping these attributes to the graphical icons, the method 300 determines initial and/or current positions of each graphical icon based on an initial and/or a current orientation, respectively, of the user interface device. At step 308, the method 300 loads each graphical icon onto the initial position within a display (e.g., the display 204 of FIG. 2) of the user interface device. After loading, the graphical icons form a screen configuration on the display.

At step 310, the method 300 determines whether an orientation of the user interface device changed. If the method 300 determines that the orientation of the user interface device did not change, the method 300 proceeds to step 312 at which the method 300 waits. In some embodiments, an accelerometer provides information (e.g., the orientation information 122 of FIG. 1) indicating the orientation of the user interface device. For example, the accelerometer may provide points that form the user interface device along a three-dimensional coordinate system. These points, hence, are three-dimensional coordinates (e.g., Cartesian coordinates, polar coordinates, and/or the like) relative to a fixed position, such as the origin (e.g., (0, 0, 0)). In some embodiments, the accelerator communicates the orientation information indicating an amount of angular displacement of the user interface device 102 about an axis (e.g., x, y or z-axis). Such an amount may be represented by an angle (e.g., degrees or radians) relative to a fixed orientation, such as an initial or previous orientation (e.g., an x-y plane). Any amount of angular displacement is an indicator of user interface device movement. It is appreciated that the orientation information may include other indicators according to other embodiments.

If, on the other hand, the method 300 determines that there is change in the orientation of the user interface device, the method 300 proceeds to step 314. In some embodiments, the method 300 examines the orientation information and determines whether there is any motion or movement of the user interface device. At step 314, the method 300 computes a new position for the each graphical icon based on at least one gravitational attribute. In response to the orientation change, the method 300 uses the at least one gravitation attribute to determines movement of the each graphical icon relative to the movement of the user interface device.

At step 316, the method 300 generates the each graphical icon at the new position. In some embodiments, the collection of graphical icons forms a screen configuration that is rendered on a touch screen (e.g., the display 204 of FIG. 2). In some embodiments, the method 300 rotates the screen configuration a number of degrees about a certain axis in response to an opposing rotation of the user interface device. Such a rotation complements the orientation change of the user interface device and provides an optimal orientation for viewing the graphical icons. The user interface device maintains this optimal orientation by rotating the screen configuration in a substantially equal but opposite direction. Accordingly, the graphical icons always face the user regardless of the orientation of the user interface device. At step 318, the method 300 ends.

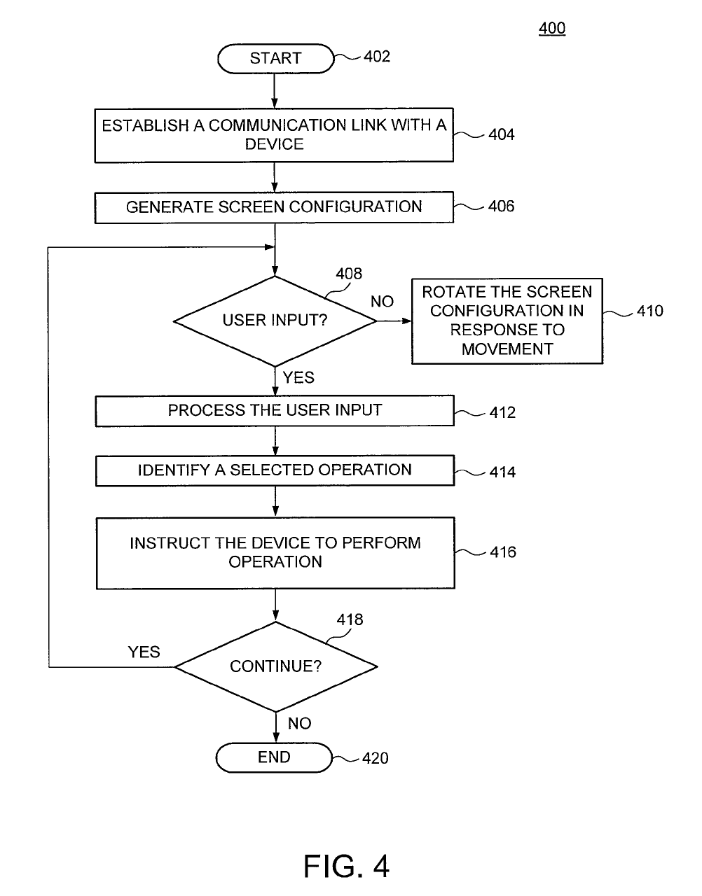

FIG. 4 illustrates a flow diagram of a method of controlling a computing device using a user interface device in accordance with at least one embodiment. Each and every step of the method 400 may be performed by a display module. In some embodiments, one or more steps are omitted. The method 400 starts at step 402 and proceeds to step 404. At step 404, the method 400 establishes a communication link with a computing device. In some embodiments, the communication link (e.g., the communication link 208 of FIG. 2) facilitates remote control over various operations at a computing device by the user interface device (e.g., the user interface device 102 of FIG. 1). At step 406, the method 400 generates a screen configuration on a display of the user interface device. The screen configuration (e.g., the screen configuration 200 of FIG. 2) of graphical icons (e.g., the plurality of graphical icons 202) is presented to a user on the display (e.g., the display 204 of FIG. 2).

At step 408, the method 400 determines whether a user inputted data to the user interface device. For example, the user may depress one or more graphical buttons activating any associated operations at the computing device. If the method 400 determines that there is user input, the method 400 proceeds to step 410. At step 410, the method 400 rotates the screen configuration in response to any movement or motion of the user interface device. If the user interface device remains in a stable orientation, the screen configuration is not changed.

At step 412, the method 400 processes the user input. At step 414, the method 400 identifies a selected operation associated with the user input. For example, the user may touch a portion of the display having a particular graphical icon that can turn a computing device on or off. At step 416, the method 400 instructs the computing device to perform the selected operation. The method 400, for example, may communicate one or more commands turning on the computing device. At step 418, the method 400 determines whether to continue controlling the computing device from the user interface device. If the method 400 decides to continue, the method 400 returns to step 408. If, on the other hand, the method 400 decides not to continue, the method 400 proceeds to step 420. At step 420, the method 400 ends.

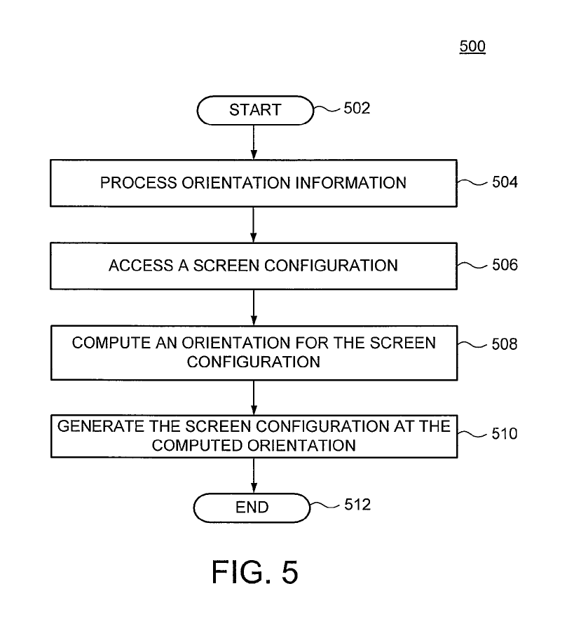

FIG. 5 illustrates a flow diagram of a method of rotating a screen configuration on a user interface device in accordance with at least one embodiment. Each and every step of the method 500 may be performed by a display module. In some embodiments, one or more steps are omitted. The method 500 starts at step 502 and proceeds to step 504. At step 504, the method 500 processes orientation information. In some embodiments, the display module examines the orientation information provided by an accelerometer (e.g., the accelerometer 114 of FIG. 1) and determines an initial orientation of the user interface device.

At step 506, the method 500 accesses a screen configuration comprising a plurality of graphical icons that are produced on a display of the user interface device. Each graphical icon is associated with a position on the display that is along the initial configuration. If the orientation information indicates a change from the initial orientation, the method 500 changes an orientation of the screen configuration to maintain an optimal viewpoint for a user. For example, movement may cause angular displacement of the user interface device about an axis.

At step 508, the method 500 computes an orientation for the screen configuration in response to the orientation change of the user interface device. For example, the method 500 determines a complimentary angular displacement for adjusting the orientation of the screen configuration in response to a rotation of the user interface device. In some embodiments, the method 500 computes the complimentary angular displacement using one or more gravitational attribute. Each attribute correspond with movement of a particular graphical icon relative to the movement of the user interface device. In other words, a gravitational attribute indicates a direction and magnitude of the complimentary angular displacement (e.g., clockwise 45) in response to the angular displacement of the user interface device. At step 510, the method 500 generates the screen configuration at the computed orientation. At step 512, the method 500 ends.

While, the present invention is described in connection with the preferred embodiments of the various figures. It is to be understood that other similar embodiments may be used. Modifications/additions may be made to the described embodiments for performing the same function of the present invention without deviating therefore. Therefore, the present invention should not be limited to any single embodiment, but rather construed in breadth and scope in accordance with the recitation of the appended claims.

1. A computer implemented method for providing a flexible display for a user interface device, comprising:
processing graphical icon information for the user interface device, wherein each graphical icon corresponds with at least one operation on the user interface device;
coupling the graphical icon information with gravity information, wherein the each graphical icon maps to at least one gravitational attribute, wherein the at least one gravitational attribute corresponds with motion of the graphical icon relative to the user interface device; and
in response to an orientation change of the user interface device, generating the each graphical icon at a position determined by the at least one gravitational attribute.

2. The method of claim 1, wherein generating the each graphical icon further comprises loading the each graphical icon at an initial position based on an initial orientation of the user interface device.

3. The method of claim 1, wherein the orientation change is caused by movement of the user interface device.

4. The method of claim 1, wherein the user interface device remotely controls a computing device.

5. The method of claim 1, wherein the user interface device is substantially circular in shape.

6. The method of claim 1 wherein generating the each graphical icon further comprising rotating a screen configuration comprising the each graphical icon in response to an opposing rotation of the user interface device, wherein the screen configuration faces a user.

7. The method of claim 6, wherein the screen configuration rotates less than ninety degrees.

8. An apparatus for providing a flexible display for a user interface device, comprising:
an display module for processing graphical icon information for the user interface device, wherein each graphical icon corresponds with at least one operation on the user interface device, coupling the graphical icon information with gravity information, wherein the each graphical icon maps to at least one gravitational attribute, wherein the at least one gravitational attribute corresponds with motion of the graphical icon relative to the user interface device and in response to an orientation change of the user interface device, generating the each graphical icon at a position determined by the at least one gravitational attribute.

9. The apparatus of claim 8 further comprising an accelerometer for providing orientation information associated with a screen configuration that comprises the each graphical icon.

10. The apparatus of claim 8, wherein the display module generates the each graphical icon further comprises loading the each graphical icon at an initial position based on an initial orientation of the user interface device.

11. The apparatus of claim 8, wherein the orientation change is caused by movement of the user interface device.

12. The apparatus of claim 8, wherein the user interface device remotely controls a computing device.

13. The apparatus of claim 8, wherein a display of the user interface device is substantially circular in shape.

14. The apparatus of claim 8, wherein generating the each graphical icon further comprising rotating a screen configuration comprising the each graphical icon in response to an opposing rotation of the user interface device, wherein the screen configuration faces a user.

15. The apparatus of claim 14, wherein the screen configuration is rotated less than ninety degrees.

16. A computer readable storage medium comprising one or more processor executable instructions that, when executed by at least one processor, causes the at least one processor to perform a method comprising:
processing graphical icon information for the user interface device, wherein each graphical icon corresponds with at least one operation on the user interface device;
coupling the graphical icon information with gravity information, wherein the each graphical icon maps to at least one gravitational attribute, wherein the at least one gravitational attribute corresponds with a motion of the graphical icon relative to an orientation of the user interface device; and
in response to an orientation change of the user interface device, generating the each graphical icon at a position determined by the at least one gravitational attribute.

17. The computer-readable-storage medium of claim 16, wherein the one or more processor executable instructions perform the method further comprising:
loading the each graphical icon at an initial position based on an initial orientation of the user interface device.

18. The computer-readable-storage medium of claim 16, wherein the one or more processor executable instructions perform the method further comprising:
controlling functionality of a computing device using a screen configuration comprising the each graphical icon.

19. The computer-readable-storage medium of claim 16, wherein the one or more processor executable instructions perform the method further comprising:
rotating a screen configuration comprising the each graphical icon in response to an opposing rotation of the user interface device, wherein the screen configuration faces a user.

20. The computer-readable-storage medium of claim 16, wherein the one or more processor executable instructions perform the method further comprising:
rotating the screen configuration less than ninety degrees.
